(19) United States
(12) Patent Application Publication
(10) Pub. No.: US 2008/0107801 A1
(43) Pub. Date: May 8, 2008

(54) METHOD OF MAKING A VARIABLE RESISTANCE MEMORY

(75) Inventors: Jolanta Celinska, Colorado Springs, CO (US); Carlos A. Paz de Araujo, Colorado Springs, CO (US); Matthew D. Brubaker, Colorado Springs, CO (US)

Correspondence Address: PATTON BOGGS LLP, 1801 CALFORNIA STREET, SUITE 4900, DENVER, CO, 80202, US

(73) Assignee: Symetrix Corporation, Colorado Springs, CO (US)

(21) Appl. No.: 11/937,481

(22) Filed: Nov. 8, 2007

Related U.S. Application Data
(60) Provisional application No. 60/858,218, filed on Nov. 8, 2006.
(60) Provisional application No. 60/904,768, filed on Mar. 2, 2007.
(60) Provisional application No. 60/906,158, filed on Mar. 9, 2007.
(60) Provisional application No. 60/913,245, filed on Apr. 20, 2007.

(51) Int. Cl. B05D 5/12

(52) U.S. Cl. 427/96.7; 252/519.2; 427/96.8; 427/99.2

(57) ABSTRACT

A method of making a variable resistance material (VRM), the method comprising providing a precursor comprising a metallorganic or organometallic solvent containing a metal moiety suitable for forming the VRM, depositing the precursor on a substrate to form a thin film of the precursor, and heating the thin film to form the VRM. The preferred solvent comprises octane.

### CROSS-REFERENCE TO RELATED APPLICATIONS

This Application is a Non-Provisional Application claiming the benefit of: Provisional (35 USC 119(e)) Application No. 60/858218 filed on Nov. 8, 2006; Provisional (35 USC 119(e)) Application No. 60/904768 filed on Mar. 2, 2007; Provisional (35 USC 119(e)) Application No. 60/906158 filed on Mar. 9, 2007; and Provisional (35 USC 119(e)) Application No. 60/913245 filed on May 21, 2007. All of the foregoing provisional applications are hereby incorporated by reference to the same extent as though fully disclosed herein.

### FIELD OF THE INVENTION

The invention in general relates to integrated circuit memories, and in particular, to the formation of non-volatile integrated circuit memories containing materials which exhibit a change in resistance.

### BACKGROUND OF THE INVENTION

Non-volatile memories are a class of integrated circuits in which the memory cell or element does not lose its state after the power supplied to the device is turned off. The earliest computer memories, made with rings of ferrite that could be magnetized in two directions, were non-volatile. As semiconductor technology evolved into higher levels of miniaturization, the ferrite devices were abandoned for the more commonly known volatile memories, such as DRAMs (Dynamic Random Access Memories) and SRAMs (Static-RAMs).

The need for non-volatile memories never went away. Thus, in the last forty years, many devices were created to fulfill this need. In the late 70's, devices were made with a metallization layer which either connected or disconnected a cell. Thus, at the factory one could set values in a non-volatile way. Once these devices left the factory, they could not be re-written. They were called ROMs Read Only Memories). In 1967, Khang and SZE at Bell Laboratories proposed devices which were made using field effect transistors (FETs) which had within layers of materials in the gate, the ability to trap charge. In the late 70's and early 80's, devices which could be written by the user and erased by de-trapping the electrons via ultra-violet light (UV) were very successful. The UV both required the device to be removed from the circuit board and placed under a UV lamp for over 15 minutes. These non-volatile memories were called were called PROMs or programmable ROMs. The writing process involved forcing current from the substrate below to these trap sites. This process of making the electrons pass through layers of materials which have an opposing potential energy barrier is known as quantum tunneling, a phenomenon that only occurs because of the wave-particle duality of the electron. Many types of sandwiches of materials for the gate stack of these FETs were tried, and the technology received many names such as MNOS (Metal-Nitride-Oxide-Semiconductor), SNOS ([Poly] Silicon-Gate Plus MNOS), SONOS (Silicon-Oxide Plus MNOS), and PS/O/PS/S Polysilicon Control Gate—Silicon Dioxide—Polysilicon Floating Gate—and a thin tunneling oxide on top of the silicon substrate). This kind of erasable and, thus, read/write non-volatile device was known as EEPROMs for electrically-erasable-PROMs, an unfortunate misnomer since they are not just read only. Typically, EEPROMS have large cell areas and require a large voltage (from 12 to 21 volts) on the gate in order to write/erase. Also, the erase or write time is of the order of tens of microseconds. However, the worse limiting factor is the limited number of erase/write cycles to no more than slightly over 600,000—or of the order of 10⁵-10⁶. The semiconductor industry eliminated the need of a pass-gate switch transistor between EEPROMs and non-volatile transistors by sectorizing the memory array in such a way that “pages” (sub-arrays) could be erased at a time in memories called Flash memories. In Flash memories, the ability to keep random access (erase/write single bits) was sacrificed for speed and higher bit density.

The desire to have low power, high speed, high density, and indestructibility has kept researchers working in non-volatile memory for the last forty years. FeRAMs (Ferroelectric RAMs) provide low power, high write/read speed, and endurance for read/write cycles exceeding 10 billion times. Magnetic memories (MRAMs) provide high write/read speed and endurance, but with a high cost premium and higher power consumption. Neither of these technologies reaches the density of Flash; thus, Flash remains the non-volatile memory of choice. However, it is generally recognized that Flash will not scale easily below 65 nanometers (nm); thus, new non-volatile memories that will scale to smaller sizes are actively being sought.

To this end, there has been much research over the last ten to twenty years on memories based on certain materials that exhibit a resistance change associated with a change of phase of the material. In one type of variable resistance memory called an RRAM, a change in resistance occurs when the memory element is melted briefly and then cooled to either a conductive crystalline state or a nonconductive amorphous state. Typical materials vary and include GeSbTe, where Sb and Te can be exchanged with other elements of same properties on the Periodic Table. These materials are often referred to as chalcogenides. See, for example, Stephan Lai, “Current Status of the Phase Change Memory and Its Future”, Intel Corporation, Research note RN2-05 (2005); U.S. Pat. No. 7,038,935 issued to Darrell Rinerson et al., May 2, 2006; U.S. Pat. No. 6,903,361 issued to Terry L. Gilton on Jun. 7, 2005; and U.S. Pat. No. 6,841,833 issued to Sheng Teng Hsu et al., Jan. 11, 2005. However, these resistance-based memories have not proved to be commercially successful because their transition from the conductive to the insulating state depends on a physical structure phenomenon, i.e., melting (at up to 600° C.) and returning to a solid state that cannot be sufficiently controlled for a useful memory.

Recently, a resistance switching field effect transistor has been disclosed using a Mott-Brinkman-Rice insulator, such as LaTiO₃. In this material, according to the theory proposed, the addition of holes via an interface with a Ba_{(1-X)}Sr_{X}TiO₃ layer changes the material from an insulator to a conductor. See U.S. Pat. No. 6,624,463 issued to Hyun-Tak Kim et al. on Sep. 23, 2003. This FET uses the Mott-Brinkman-Rice insulator as the channel in the FET. However, no examples of fabrication of actual devices is given.

Another variable resistance memory category includes materials that require an initial high “forming” voltage and current to activate the variable resistance function. These materials include PrₓCa_{y}Mn_{z}Oₑ, with x, y, z and c of varying stoichiometry; transition metal oxides, such as CuO, CoO, VOₓ, NiO, TiO₂, Ta₂O₅; and some perovskites, such as Cr doped SrTiO₃. See, for example, “Resistive Switching Mechanisms of TiO₂ Thin Films Grown By Atomic-Layer Deposition”, B. J. Choi et al., Journal of Applied Physics 98, 033715 (2005); “Reproducible Resistive Switching In Nonstoichiometric Nickel Oxide Films Grown By RF Reactive Sputtering For Resistive Random Access Memory Applications”, Jae-Wan Park, et al., J. Vac. Sci. Technol. A 23(5), September/October 2005; “Influence Of Oxygen Content On Electrical Properties Of NiO films grown By RF Reactive Sputtering”, Jae-Wan Park, et al., J. Vac. Sci. Technol. B 24(5), September/October 2006; “Nonpolar Resistance Switching Of Metal/Binary-Transition-Metal Oxides/Metal Sandwiches: Homogeneous/inhomogeneous Transition of Current Distribution”, I. H. Inone et al., arXiv:Condmat/0702564 v.1, 26 Feb. 2007; and United States Patent Application Publication No. 2007/0114509 A1, Memory Cell Comprising Nickel-Cobalt Oxide Switching Element, on an application of S. Brad Herner. These memories are referred to as ReRAMs, to distinguish them from the chalcogenide type memories. Further, none demonstrate conductive and insulative states that are stable over the necessary temperature range and which do not fatigue over many memory cycles. In relation to variable resistance materials, fatigue means that the difference in resistance between the conducting and non-conducting states changes significantly as the memory is cycled through many changes of memory state. Such fatigue takes a memory out of specification with the result that it no longer works.

FIG. 1 is an Arrhenius curve of the log of 1/Tau versus 1/T(1/K) for prior art sputtered NiO, illustrating that the transition from the high resistance state to the low resistance state in this typical prior art resistive switching material is caused by detrapping of electrons from oxygen vacancies in the sputtered NiO. To generate this Arrhenius curve, the relaxation time for the material to return to the insulative state after SET, Tau, was measured for a number of temperatures in the working range of a proposed variable resistance memory (below 70° C.) for NiO films made by sputtering. As is known in the art, the slope of the Arrhenius curve 960 is proportional to the activation energy for the mechanism that is causing the relaxation. The slope found from curve 960 yields an activation energy of approximately 0.47 eV. This is essentially the activation energy for detrapping of electrons from oxygen vacancies in NiO. See “Surface Metallic Nature Caused By An In-Gap State Of Reduced NiO: A Photoemission Study”, N. Nakajima et al., Journal of Electron Spectroscopy and Related Phenomena, 144 147 (2005) pp. 873-875. Thus, the variable resistance phenomenon of the prior art NiO devices is dominated by the trapping and detrapping of electrons in oxygen vacancies. Since trapping is strongly temperature dependent, such a resistive switching mechanism must also be highly temperature dependent; therefore, it cannot form the basis for a commercially useful memory. Similarly, all other prior art resistive switching materials exhibit unstable qualities. Moreover, based on the ReRAM art to date, the use of such materials must be said to be speculative, since the high voltage-high current forming step simply is not compatible with dense chip architecture. In fact, the patent reference merely speculates that a combination of nickel and cobalt oxides will eliminate the required high amplitude pulses, without providing an actual example to demonstrate it.

In summary, there have been literally hundreds, if not thousands, of papers and patent applications written on resistive memories in the last ten years, most of which have been speculative. However, a workable resistance switching memory has never been made, because no one knows how to make a thin film resistance switching material that is stable over time and temperature. Further, all resistance switching mechanisms developed up to now have been inherently unsuitable for memories, due to high currents, electroforming, no measurable memory windows over a reasonable range of temperatures and voltages, and many other problems. Thus, there remains a need in the art for a non-volatile memory and process of making it that results in stability over time and temperature. Moreover, if at the same time the material did not require electroforming, such a material and process of making it would be highly desirable.

### BRIEF SUMMARY OF THE INVENTION

The invention solves the above and other problems by providing methods for making resistive switching materials, generally called variable resistance materials (VRM) in the art, memories utilizing such materials, and integrated circuits utilizing the materials. In particular, chemical solution deposition (CSD) methods, preferably utilizing a metallorganic or organometallic precursor, and most preferably, having octane as a solvent, are disclosed. CSD methods include spin-on, misted deposition, metallorganic chemical vapor deposition (MOCVD), dipping, and atomic layer deposition (ALD). Preferably, the chemical solution provides the element carbon. These methods preferably include a reaction in a gas containing the extrinsic ligand elements that stabilize the VRM or a gas containing the anion to which the ligand bonds, or both. The reaction may take place in an anneal process in a gas containing the ligand, the anion, or both; or the reaction may take place in a reactive sputtering in a gas containing the ligand, the anion, or both.

The invention provides a method of making a resistive switching integrated circuit memory, said method comprising: providing a substrate and a metallorganic or organometallic precursor including a metal moiety suitable for forming a desired variable resistance material (VRM); applying said precursor to said substrate to form a thin film of said precursor; heating said precursor on said substrate to form said VRM; and completing said integrated circuit to include said VRM as an active element in said integrated circuit. Preferably, said precursor comprises octane. Preferably, said applying comprises a process selected from the group consisting of: spin-coating, dipping, liquid source misted deposition, chemical vapor deposition, and atomic layer deposition. Preferably, said heating comprises annealing in oxygen. Preferably, said heating comprises annealing in a gas containing at least one chemical element for forming a ligand which stabilizes the electronic properties of said VRM. Preferably, said gas comprises a gas selected from CO and CO₂. Preferably, said annealing comprises annealing in a gas containing the anion for said VRM. Preferably, said metal comprises nickel. Preferably, said method further comprises patterning said resistance switching material using an etch. Preferably, said etch comprises ion milling or reactive ion etching (RIE). Preferably, said heating comprises drying said thin film at a temperature between 100° C. and 300° C. and then annealing said thin film in a furnace at a temperature of between 450° C. and 650° C.

The invention also provides a method of making a variable resistance material (VRM), said method comprising: providing a metallorganic or organometallic precursor including a metal moiety suitable for forming a desired variable resistance material (VRM); applying said precursor to a substrate to form a thin film of said precursor; and heating said precursor on said substrate to form said VRM. Preferably, said precursor comprises octane. Preferably, said applying comprises a process selected from the group consisting of: spin-coating, dipping, liquid source misted deposition, chemical vapor deposition, and atomic layer deposition. Preferably, said heating comprises annealing in oxygen. Preferably, said heating comprises annealing in a gas containing at least one chemical element for forming a ligand which stabilizes the electronic properties of said VRM. Preferably, said gas comprises a gas selected from CO and CO₂. Preferably, said metal moiety comprises nickel.

The invention further provides a precursor for making a variable resistance material (VRM), said precursor comprising a metallorganic solvent and one or more metals. Preferably, said metallorganic solvent comprises octane. Preferably, said metal comprises a transition metal. Preferably, said transition metal comprises nickel.

The invention provides a method of making a resistive switching material that results in resistive switching properties that are stable over time and temperature. In addition, the material does not require electroforming to enter the variable resistance state. Numerous other features, objects, and advantages of the invention will become apparent from the following description when read in conjunction with the accompanying drawings.

### BRIEF DESCRIPTION OF THE DRAWINGS

FIG. 1 is an Arrhenius curve of the log of 1/Tau versus 1/T(1/K) for prior art sputtered NiO (without carbon), illustrating that the transition from the high resistance state to the low resistance state is caused by detrapping of electrons from oxygen vacancies in the sputtered NiO;

FIG. 2 is a flow chart showing the process of fabricating conductor/variable resistor/conductor integrated circuit elements according to the invention;

FIG. 3 illustrates a silicon wafer with variable resistor “elements” made by the process of FIG. 2;

FIG. 4 shows a cross-sectional view of one of the “elements” of FIG. 3 taken through the line 4-4 of FIG. 3;

FIG. 5 shows the current in amperes versus bias voltage in volts curves for an NiO resistor according to the invention;

FIG. 6 shows the same curves as shown in FIG. 5 except on a logarithmic scale which shows higher resolution at the smaller values of current;

FIG. 7 is a graph of voltage versus current illustrating the SET and RESET functions for an NiO element having a diameter of 50 microns;

FIG. 8 is a graph of voltage versus current illustrating the SET and RESET functions for a NiO element with the VRM material doped with 5% cobalt and having a diameter of 50 microns;

FIG. 9 show graphs of voltage versus current illustrating the SET and RESET functions for three NiO elements having different diameters illustrating how the memory window changes with element diameter;

FIG. 10 show graphs of voltage versus current in the high resistance state for four NiO sandwiches having different diameters;

FIG. 11 show graphs of voltage versus current density in the high resistance state for the four elements of FIG. 10;

FIG. 12 shows a graph of current in amps versus bias voltage in volts for the ON and OFF states after the NiO VRM was held at 150° C. for five minutes;

FIG. 13 shows a graph of resistance in Ohms versus temperature in degrees centigrade for the ON and OFF states illustrating the stability of these states at higher temperatures;

FIG. 14 shows an idealized current versus voltage curve for a resistive switching film with unipolar switching, illustrating the ON, OFF, RESET, and SET modes;

FIG. 15 is a cross-sectional view of a 1 transistor/1 resistor VRM switching cell according to the invention;

FIG. 16 illustrates an exemplary memory utilizing any of the memory cells disclosed herein;

FIG. 17 shows a graph of Kelvin temperature versus resistance in Ohms for the ON and OFF states for a VRM thin film according to the invention and for a prior art thin film that crystallizes in the OFF state and requires forming before exhibiting variable resistance; and

FIG. 18 is a graph of number of reading cycles versus resistance in Ohms for the ON and OFF states for a VRM thin film according to the invention, demonstrating that there is little or no fatigue.

### DETAILED DESCRIPTION OF THE INVENTION

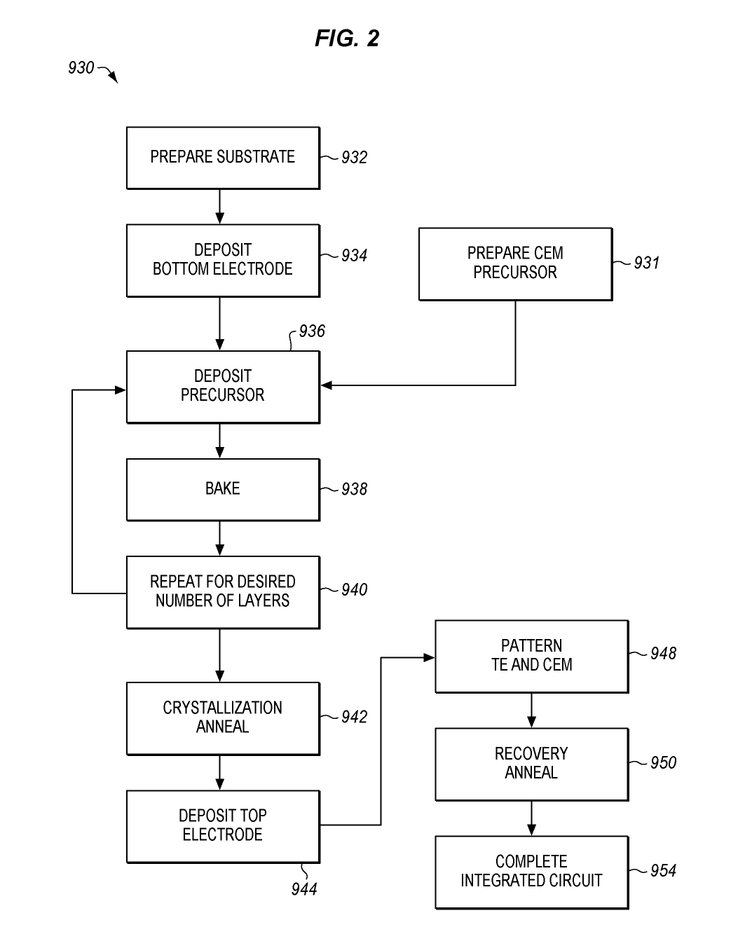

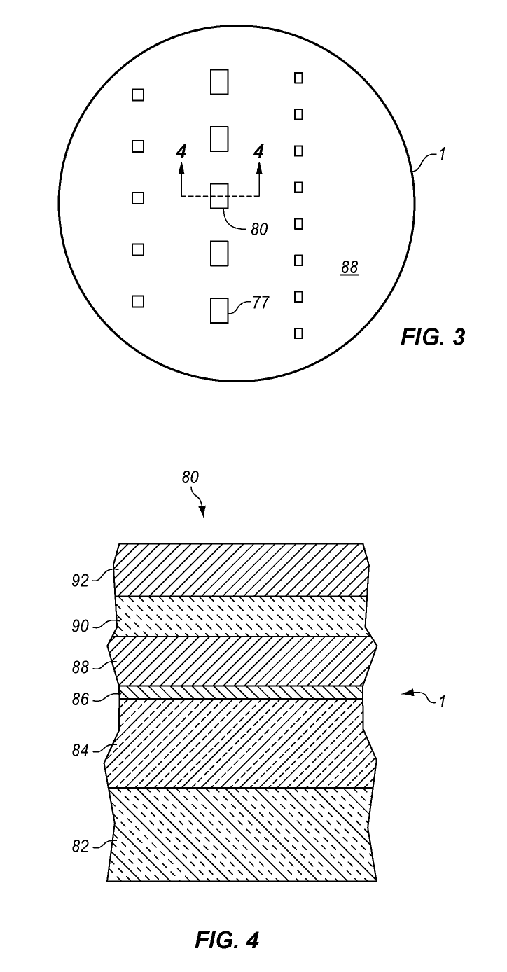

The invention pertains to a method of making variable resistance materials, memories, and integrated circuits such that they are stable over time and temperature. In this disclosure, a variable resistance material may be referred to as a VRM. FIG. 2 is a flow chart showing the preferred process 930 of fabricating a variable resistance integrated circuit element. The sample variable resistance integrated circuit elements actually fabricated by the process are shown in FIGS. 3 and 4. However, those skilled in the art will understand that, based on the results described below, many other variable resistance structures may be formed that will be stable over time and temperature.

Turning to FIGS. 3 and 4, a silicon wafer 1 having VRM integrated circuit elements, such as 77 and 80, formed on it is shown. FIG. 4 shows a cross-section through element 80 taken through line 4-4 of FIG. 3. Element 80 is formed on a silicon substrate 82 having a silicon dioxide coating 84. Optionally, a thin layer 86 of titanium or titanium oxide may be formed on oxide layer 84, though the elements reported on herein did not have such a layer. A layer 88, preferably of platinum, is formed on either layer 86 or directly on oxide layer 84. Layer 86 is an adhesion layer to assist the platinum in adhering to silicon dioxide layer 84. VRM material 90 is formed on platinum bottom electrode 88, preferably by a liquid deposition process such as spin coating, misted deposition, CVD, or atomic layer deposition. Top electrode 92, preferably platinum, then is formed on VRM layer 90. The elements 77, 80, etc. then are patterned by etching down to bottom electrode 88. The various elements 77, 88 then can be tested by attaching one probe to platinum surface 88 and touching a fine probe to the top electrode, such as 92, of the element to be tested, such as 80. The various curves discussed below were generated in this manner.

It should be understood that figures such as FIGS. 3, 4, and 15 depicting integrated circuit devices are not meant to be actual plan or cross-sectional views of any particular portion of actual integrated circuit devices. In actual devices, the layers will not be as regular and the thicknesses may have different proportions. The various layers in actual devices often are curved and possess overlapping edges. Instead, the figures show idealized representations which are employed to explain more clearly and fully the method of the invention than would otherwise be possible. Also, the figures represent only one of innumerable variations of devices that could be fabricated using the designs and methods of the invention. As is conventional in the art, the term “metal” when referring to an electrode or other wiring layer generally means a conductor. As is known in the art, such “metal” electrodes and/or wiring layers can be made of polysilicon or other conductive material and are not necessarily made of metal.

In process 932, a substrate is prepared. The substrate is preferably a silicon wafer with a silicon oxide coating. The substrate may be baked to remove any contaminants. Simultaneously, at 931, a VRM precursor is prepared. The precursor contains metal moieties suitable for forming the desired VRM or other variable resistance material upon deposition and heating. For example, if nickel oxide is the desired variable resistance material, then the precursor will contain nickel. The precursor is preferably a liquid containing carbon, preferably a metallorganic or organometallic precursor. This may be an off-the-shelf precursor purchased from a chemical company, such as Kojundo Chemical Co. of Tokyo Japan; or the precursor may be prepared just prior to deposition.

At 934, a bottom electrode is deposited. This electrode may include an adhesion layer and/or a barrier layer as is known in the art. Preferably, the electrode is platinum. The precursor then is deposited in process 936. They may be any of the processes mentioned above. After depositing, the precursor is heated to form a crystallized VRM or other variable resistance material. In the preferred embodiment, the heating process comprises a bake process 938 and an anneal process 942. However, a wide variety of heating processes may be used, including baking on a hot plate, furnace anneal, rapid thermal processing (RTP), sometimes called rapid thermal annealing (RTA), or any other process that will crystallize the film. In process 938, the deposited precursor on the wafer is baked, preferably on a hot plate, and preferably at a temperature between 100° C. and 300° C. for a time of between one minute and ten minutes. Preferably, two bakes are used at different temperatures, more preferably with the second bake at the higher temperature. The deposition and bake steps are repeated at 940 for as many times as required to obtain the desired thickness of films. After the desired thickness is reached, the dried layers are annealed to form a crystatlized film at 942. Preferably, the annealing is at a temperature of from 450° C. to 650° C., with the lower temperature most preferred, and is for a time from 20 minutes to 1 hour. The anneal may be performed in oxygen or in a gas containing a desired ligand. At 944, the top electrode is deposited. This is preferably platinum.

The top electrode and VRM material then is patterned, preferably by a dry etch, more preferably ion milling or reactive ion etching (RIE), and most preferably by ion milling with argon. The etch has been found to be helpful in obtaining stable materials. Then follows a recovery anneal, preferably at a temperature of from 450° C. to 650° C. and preferably for from 30 minutes to 1.5 hours, and preferably, in oxygen. The integrated circuit then is completed at 954 to include the VRM material as an active element in an integrated circuit. Here, “active element”means an element that changes in response to the application of current or voltage.

### EXAMPLE I

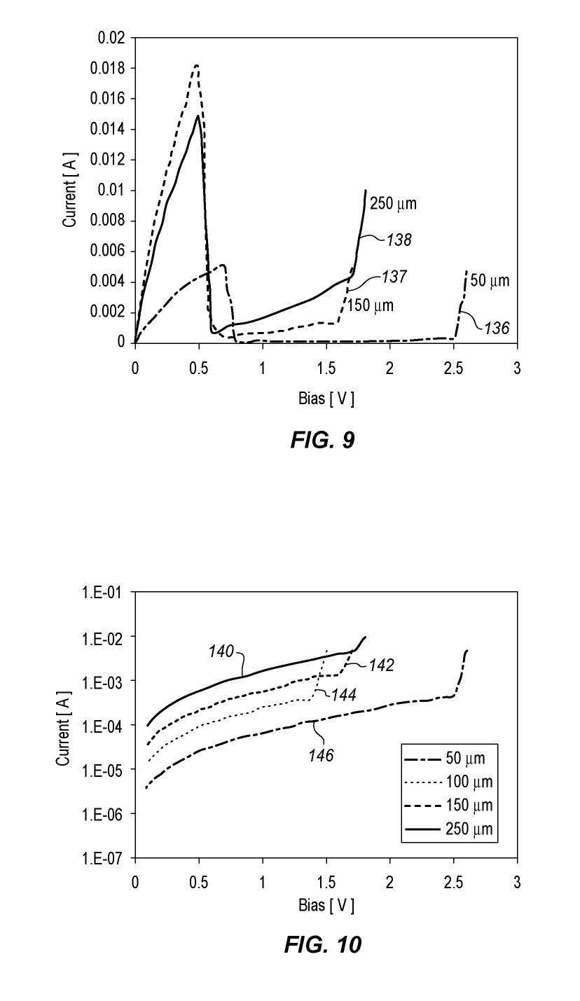

A 2000 Å (Angstrom) layer of platinum was deposited on a wafer with a silicon dioxide coating. Then a 0.2 molar nickel oxide precursor in an octane solution was deposited by spin coating the platinum layer at 3000 rpm (rounds per minute). The nickel oxide precursor is available from Kojundo Chemical Company, Tokyo, Japan. The precursor was baked at 150° C. for 1 minute, and then at 260° C. for four minutes to produce an approximately 100 Å dry layer. The spin-on deposition and baking processes were repeated six times for a total thickness of 600 Å. Then a crystallization anneal was performed in a furnace at 450° C. in an oxygen atmosphere for 40 minutes to produce a 600 Å layer of the VRM nickel oxide according to the invention. Electron microscopy revealed that a significant amount of carbon was present in the material, with the carbon coming from the octane precursor. Since both a metallorganic precursor and an organometallic precursor contain carbon, either precursor can be used. A top electrode of 2000 Å of platinum was deposited. Then the top electrode and VRM layer were patterned by dry etching, preferably ion milling, down to the bottom electrode platinum layer. Finally, a recovery anneal was performed in a furnace at 450° C. in an oxygen atmosphere for approximately one hour to produce the films discussed with respect to FIGS. 9-12 above.

### EXAMPLE II

This example was made in the same way as Example I above except that 5% ammonia was added to the precursor. The films produced yielded similar results.

The invention includes an annealing process for VRMs. The VRM may be annealed in a gas containing at least one chemical element for forming a ligand which stabilizes the electronic properties of the VRM. Preferably, the VRM is a transition metal and the chemical element comprises carbon. Preferably, the gas comprises a gas selected from CO and CO₂. Preferably, the VRM is nickel.

The invention also provides a sputtering method of making a VRM. The material may be sputtered and then annealed as described above; or reactive sputtering of the VRM in a gas containing at least one chemical element for forming a ligand which stabilizes the electronic properties of the VRM may be employed. Preferably, the VRM is a transition metal and the chemical element comprises carbon. Preferably, the gas comprises a gas selected from CO and CO₂. Preferably, the VRM is nickel oxide.

The present disclosure focuses on transition metal oxide variable resistance materials, though the invention is applicable to other variable resistance materials as well. Nickel oxide, NiO, is disclosed as the exemplary transition metal oxide. All of the NiO materials discussed herein are doped with extrinsic ligands which stabilize the variable resistance properties. In general, this may be written as NiO(Lₓ), where Lₓ is a ligand element or compound and x indicates the number of units of the ligand for one unit of NiO. One skilled in the art can determine the value of x for any specific ligand and any specific combination of ligand with NiO or any other transition metal simply by balancing valences. The NiO variable resistance materials made included a carbon containing ligand, which may be indicated by NiO(Cₓ). However, at times, the nickel oxide with carbon ligand may be written NiO, though it should be understood that a carbon extrinsic ligand is present, unless specifically stated otherwise.

The exemplary variable resistance materials discussed herein are correlated electron materials (CEMs), since these are the most stable variable resistance materials known. A CEM is disclosed in detail in co-pending U.S. patent application Ser. No. 11/937461, which is hereby incorporated by reference to the same extent as though fully disclosed herein. A brief description follows. A CEM is a material that switches from a first resistive state to a second resistive state, with the second resistive state having a resistance at least one hundred times higher than the first resistance state, and the change in resistance is primarily due to correlations between electrons. Preferably, the CEM material changes from a paramagnetic conductive state to an anti-ferromagnetic insulative state when the Mott transition condition (n_{C})^{1/3}a=0.26 is reached, where n_{C} is the concentration of electrons and “a” is the Bohr radius. More preferably, the resistance of the second state is at least two hundred times the resistance of the first state, and most preferably, five hundred times. Generally, these materials include any transition metal oxide, such as perovskites, Mott insulators, charge exchange insulators, and Anderson disorder insulators. Several embodiments representing switching materials are nickel oxide, cobalt oxide, iron oxide, yttrium oxide, and perovskites such as Cr doped strontium titanate, lanthanum titanate, and the manganate family including praesydium calcium manganate and praesydium lanthanum manganate. In general, oxides incorporating elements with incomplete d and f orbital shells exhibit CEM resistive switching properties. Preferably, resistance can be changed by setting at one voltage and resetting at a second voltage. Preferably, the CEM is crystallized in the conducting state, and no electroforming is required to prepare a CEM. The invention contemplates that many other transition metal compounds can be used in the invention. For example, {M(chxn)₂Br}Br₂ where M can be Pt, Pd, or Ni, and chxn is 1R,2R-cyclohexanediamine, and other such metal complexes may be used.

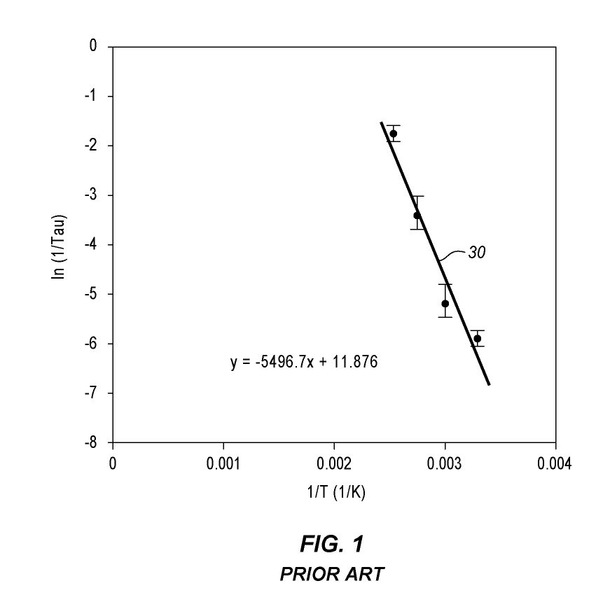

FIG. 1 shows the current in amperes (amps) versus bias voltage in volts curves for an NiO(Cₓ) VRM according to the invention. FIG. 2 shows the same curves except the absolute value of the current is plotted logarithmically to show more detail in the low current values. As has become the nomenclature in the art, the point at which the VRM changes in resistance from a conductor to an insulator is called the RESET point, while the point at which the resistance changes from an insulator to a conductor is called the SET point. Unlike other variable resistance materials, the VRMs made according to the invention crystallize in the conducting state. We shall refer to this as the ON state, and the insulative state will be called the OFF state. The solid line 40 is the ON state curve for positive voltages, and the solid line 60 is the ON curve for negative voltages. The dotted line 54 is the OFF curve for positive voltages, while the dotted line 62 is the OFF curve for negative voltages. As the voltage is increased, the current rises at 47, until the RESET voltage is reached, which is about 0.65 volts, which is also the point at which critical electron density is reached; then, at point 48, the material suddenly becomes insulative and the current drops sharply along curve 49. The current stays low along the line 52 as the voltage rises until the SET voltage is reached at about 1.65 volts, which corresponds to the Neel temperature for these materials, at which point the material again becomes conductive and the current rises along line 54. If the voltage is returned to zero and then raised again when the VRM is in the insulative state, the current follows the line 44, while, if the voltage is returned to zero after the material becomes conducting, that is after the V_{SET} point, the current follows the line 47. It is evident from FIGS. 1 and 2 that the write memory window exists between V_{RESET} and V_{SET}, while the read memory window exists between the ON and OFF state current level. It is also evident from FIGS. 1 and 2 that these memory windows are easily large enough for a viable commercial memory.

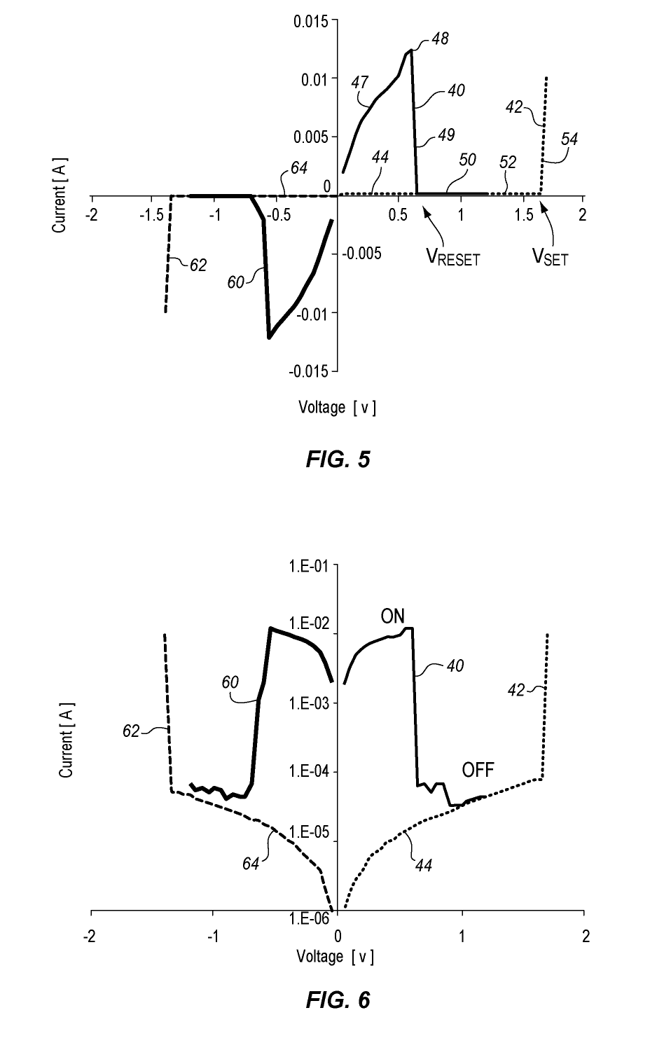

FIG. 5 is a graph of voltage versus current illustrating the SET and RESET functions for a NiO resistor having a diameter of 50 microns, and FIG. 6 is a graph of voltage versus current illustrating the SET and RESET functions for a NiO resistor doped with 5% cobalt and having a diameter of 50 microns. FIG. 5 is similar to the curve of FIG. 1 discussed above and is presented to facilitate comparison with FIG. 6. The general shape of the ON curves 110 and 122 and 114 and 130 remain essentially the same, as do the shape of the OFF curves 112 and 127. When comparing the curves of FIGS. 31 and 32, it is observed that the RESET point 115 of the NiO(Lₓ) VRM is at about 0.8 volts, while the RESET point 125 of the VRM doped with cobalt is about 1.15 volts. Further, the SET point 116 for the NiO(Lₓ) VRM is at about 2.5 volts, while the SET point 129 of the VRM doped with cobalt is about 3 volts. Further, the width W of window 120 is about 1.75 volts, while the width W of window 132 is about 1.85 volts. Thus, the onset of the insulative state has shifted with the overall window W widening. These figures indicate that, with selective doping, the onset of the states and the width of the voltage window can be adjusted.

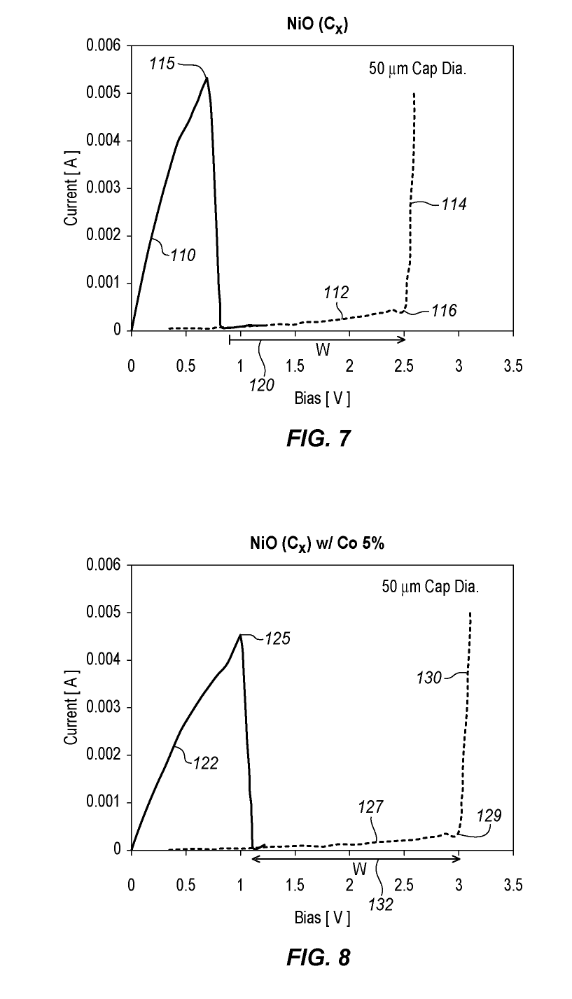

FIG. 7 shows graphs 136, 137, and 138 of voltage versus current illustrating the SET and RESET functions for three NiO sandwich elements having diameters of 50 microns, 150 microns, and 250 microns, respectively, illustrating how the memory window changes with element diameter. FIG. 8 shows graphs 140, 142, 144, and 146 of voltage versus current in the high resistance state for four NiO sandwich elements having diameters of 250 microns, 150 microns, 100 microns, and 50 microns, respectively; and FIG. 9 shows graphs 148, 150, 152, and 154 of voltage versus current density in the high resistance state for the four elements, respectively, of FIG. 8.

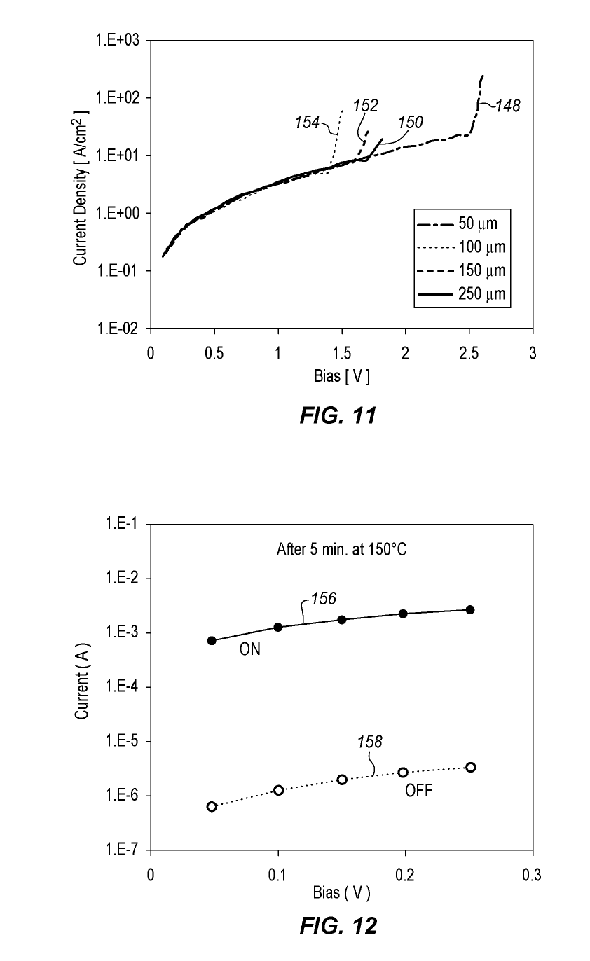

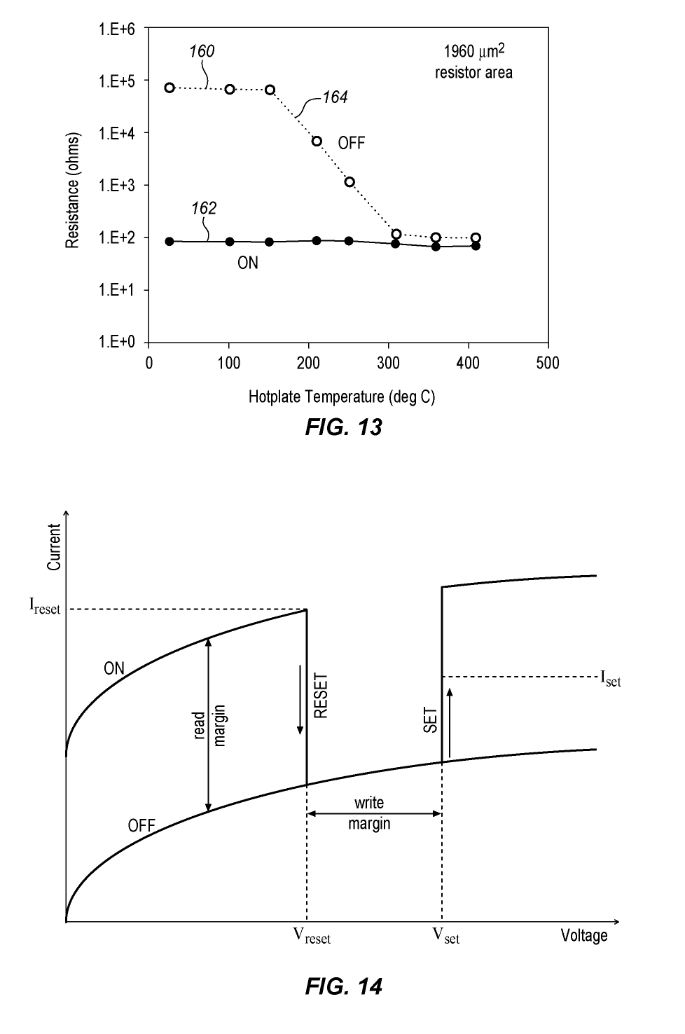

FIG. 10 shows a graph of current in amps versus bias voltage in volts after the NiO phase change material was held at 150° C. for five minutes. This graph shows no degradation of the ON state 156 or OFF state 158, indicating the temperature stability of the resistance change phenomenon according to the invention. FIG. 11 shows a graph of resistance in Ohms versus hot plate temperature in degrees centigrade. To generate this curve, the VRM elements were placed on a hot plate and heated to the temperature shown. This graph shows that the OFF state 160 degrades above 150° C., as shown by the declining curve 164, but the ON state 162 did not degrade. Above 410° C., switching ability was not regained for the OFF state and was regained only with difficulty of the ON state. This graph demonstrates that memories made with the VRM material according to the invention should be stable at all reasonable temperatures.

FIG. 14 shows an idealized current versus voltage curve for a resistive switching film with unipolar switching to better illustrate the ON, OFF, RESET, and SET modes. The material is crystallized in the ON state, and the current rises along the ON curve as voltage is increased up V_{RESET}. The current then drops to the OFF curve and increases gradually along the OFF curve until V_{SET} is reached, at which point it increases toward the ON curve. However, in devices, the current is limited to the dotted line, Iₛₑₜ to prevent overcurrent. The read and write margins are shown in the figure. As shown by FIGS. 6 and 7, the NiO(Cₓ) films according to the invention follow these idealized curves better than any prior art material.

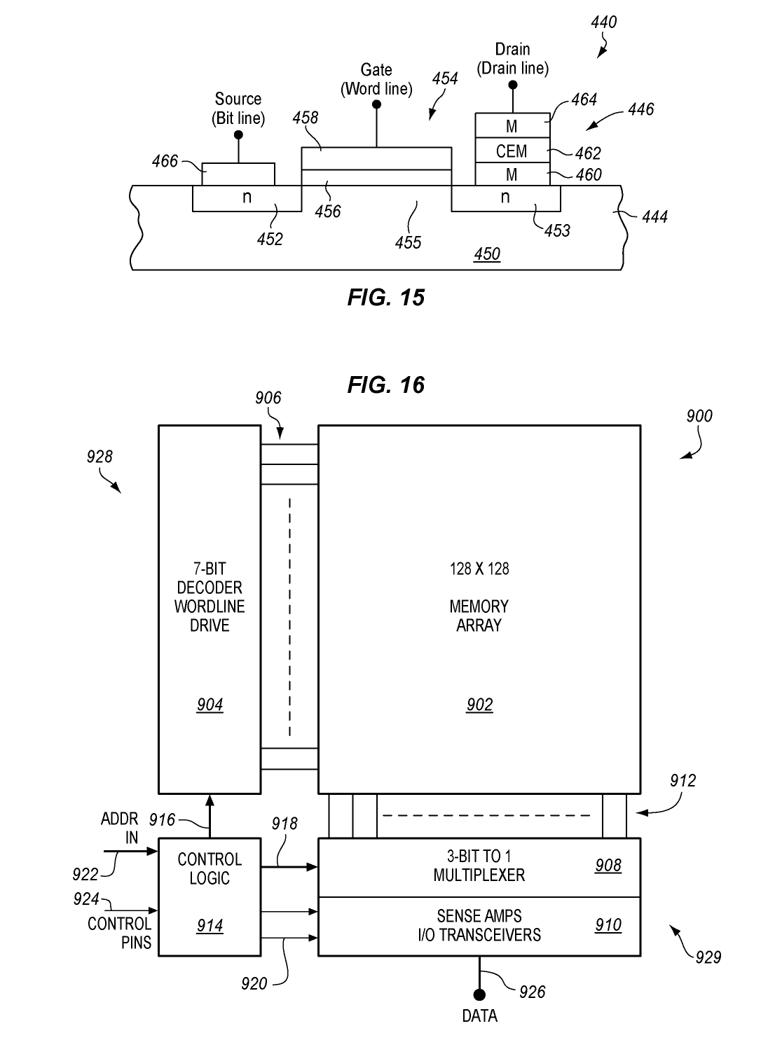

FIGS. 15 and 16 illustrate a non-volatile memory according to the invention. In this context, the word “substrate” can mean the underlying semiconductor material 82 (FIG. 4) or 444 (FIG. 15) on which the integrated circuit is formed, as well as any object, such as layer 88 in FIG. 4, on which a thin film layer, such as 90, is deposited. In this disclosure, “substrate” shall generally mean the object to which the layer of interest is applied. For example, when we are talking about a thin film 90 of FIG. 4, the substrate on which it is initially deposited may include various elements, in particular, bottom electrode 88.

The long horizontal dimensions of substrates 82, 444 define planes that are considered to be a “horizontal” plane herein, and directions perpendicular to this plane are considered to be “vertical”. The terms “lateral” or “laterally” refer to the direction of the flat plane of the semiconductor substrate, that is, parallel to the horizontal direction. Terms of orientation herein, such as “above”, “top”, “upper”, “below”, “bottom”, and “lower” mean relative to substrate 82, 444. That is, if a second element is “above” a first element, it means it is farther from semiconductor substrate 82, 444; and if it is “below” another element, then it is closer to semiconductor substrate 82, 444 than the other element. Terms such as “above”, “below”, or “on” do not, by themselves, signify direct contact. However, terms such as “directly on” or “onto” do signify direct contact of one layer with an underlying layer. However, “directly above” does not require direct contact, but rather means that if a line is drawn perpendicular to the underlying substrate and the line passes through the first element, it also will pass through the second element. It is understood that thin films of VRM fabricated in accordance with the invention have various shapes and conform to various topographies and features of an integrated circuit substrate. Accordingly, thin films of VRM in accordance with the invention are formed on planar substrates, in trenches and vias, on vertical sidewalls, and in other various non-horizontal and three-dimensional shapes.

The term “thin film” is used herein as it is used in the integrated circuit art. Generally, it means a film of less than a micron in thickness. The thin films disclosed herein are typically less than 500 nanometers (nm) in thickness. A thin film of correlated electron material fabricated by a method in accordance with the invention typically has a final thickness in a range of about from 20 nm to 300 nm, preferably in a range of about from 25 nm to 150 nm. The thin films having a thickness of about 60 nm or less are specifically designated “ultra-thin films” in this specification.

FIG. 15 is a cross-sectional view of a 1 transistor/1 resistor VRM switching cell 440 according to the invention. Cell 440 is formed on semiconductor wafer 444, which is preferably p-type silicon, but may be any other semiconductor. N-type active areas 452 and 453 are formed in wafer 444, and gate insulator 456 and gate 458 are formed over channel region 455 between the active areas as in conventional CMOS structures. A VRM device 446 is formed on one active area 453 and a metallization contact layer 466 is formed on the other active area 452. VRM device 446 comprises bottom electrode 460, VRM layer 462, and top electrode 464. While this structure is similar to 1T/1C DRAM and ferroelectric memory structures, VRM layer 462 does not store charge but rather switches resistance states. The resistance state can be identified by the voltage drop across the VRM device 446.

FIG. 16 is a block diagram of a memory circuit 900 including an exemplary variable resistance material memory array 902 according to the principles of the present invention connected to write and read circuitry. The memory cells in VRM memory array 902 may be any of the memory cells described above. In one embodiment, VRM memory array 902 is formed of 128×128 memory cells. However, VRM memory array 902 may have virtually any size as understood in the art. VRM memory array 902 may be connected to a 7-bit decoder word line drive circuit 904 via word lines 906. VRM memory array 902 may be further coupled to a 3-to-1 bit multiplexer 908 and sense amplifiers/input-output transistors 910 via bit lines 912. Control logic circuitry 914 may be in communication with (i) the decoder 904 via control lines 916, (ii) multiplexer 908 via control lines 918, and (iii) sense amplifier 910 via control lines 920. External input lines may include an address input line 922 and control lines 924. A data output line 926 may be used to output data from memory circuit 900 via sense amplifiers/transceivers 910.

In operation, an external processor may be used to drive the control logic 914. Control logic circuitry 914 communicates with decoder 904, multiplexer 908, and sense amplifiers 910, which, in combination, are used to write data into VRM memory array 902 and read data stored in memory array 902. Control logic 914 and decoder 904 comprise a write circuit 928 for placing the resistive switching memory cell in a first resistive state or a second resistive state depending on information input into the memory; and control logic 914, multiplexer 908, and sense amps 910 comprise a read circuit 929 for sensing the state of the memory cell and providing an electrical signal corresponding to the sensed state of the memory cell. As is known in the art, the first resistance state may correspond to a logic “0” state, and the second resistance state may correspond to a logic “1” state, or vice versa. Herein, for convenience, we have referred to the first resistance state as the ON or low resistance state and the second resistance state as the OFF or high resistance state.

The correlated electron resistance switching material is particularly suited for memories, preferably non-volatile memories. A wide variety of such memories are possible, some of which have been discussed above.

Since a VRM retains the resistance state it is placed in indefinitely with no voltage or electric field applied to it, all of the VRM devices described herein are inherently non-volatile switching devices. As is known in the art, non-volatile switching devices can be used as or in non-volatile memories. Thus, all of the devices described above also comprise a non-volatile memory cell, or cells in the case of the structures which show multiple VRM elements. Thus, it should be understood that, whether the device has been referred to as a VRM, switch, a switching cell, a memory cell, or a memory in the above discussion, it has been determined by the context, and in all cases the other terms apply also.

A CEM memory cell is written to by applying either a SET or RESET voltage between the top electrode 92, 464 and the bottom electrode 88, 460. The CEM switching cell 440 of FIG. 15 can be read similarly to a ferroelectric or DRAM memory using the select transistor 454 to select the cell to be read or written. A voltage or current is placed across the cells, and the resistance state of the CEM determines the voltage or charge developed across the cell and by sense amplifiers 910. It is evident that, if the CEM is conductive, the voltage drop across the CEM will be much smaller than the voltage drop when the CEM is insulating. It is evident that this read can be described in terms of reading a resistance, a voltage, or a current. That is, referring to FIG. 5, if a read voltage of, say, about 0.3 volts, is placed across the cell, there will be a large resistance, voltage, or current difference between a cell that is in the state represented by curve 47 and a cell that is in the state represented by the curve 44. In any description, it is evident that the read is inherently non-destructive because the read voltage is well below V_{RESET} and V_{SET}.

It is also evident that the preferred material of the invention is a CEM, but the process of the invention can be applied to any variable resistance material.

According to one aspect of the invention, thin films of resistive correlated electron material, such as nickel oxide, are deposited via a liquid deposition process, preferably a process in which carbon is introduced into the material. These processes include MOCVD, spin on, dipping, liquid source misted deposition, atomic layer deposition (ALD), other CSD (chemical solution deposition) methods, or by depositing a metal and then oxidizing it. In the CSD processes, metallorganic precursors are deposited and reacted to form the desired material. Octane is the preferred solvent for the transition oxide precursors. Single layer films showed cracking, but multilayer films were of electronic device quality. An octane precursor provided the best results. These represent “first try” results, and the experience of the Applicants indicates that good extremely thin films are possible with any liquid source deposition process, including MOCVD, and with the process of depositing a metal and then oxidizing it. Results with a furnace anneal of 450° C. show that, on Pt, the films are smooth and are fine-grained. Applicants have shown that the results remain good with anneals in the range of 550° C. to 650° C. Also, as discussed more fully elsewhere, it is found to be advantageous to include carbon ligand doping in the material. Further, it has been found that annealing in a gas containing the ligand materials is advantageous. Further, the gas preferably also includes the anion to which the ligand bonds the metal. For example, annealing of nickel oxide in carbon monoxide (CO) or carbon dioxide (CO₂) provides the carbon ligand and the oxygen anion in the metal-ligand-anion bonds that stabilize the nickel oxide. Alternatively, the CEM materials may be sputtered and then annealed in the ligand-containing gas, or may be reactive sputtered in the ligand-containing gas. For example, nickel may be reactive sputtered in CO or CO₂.

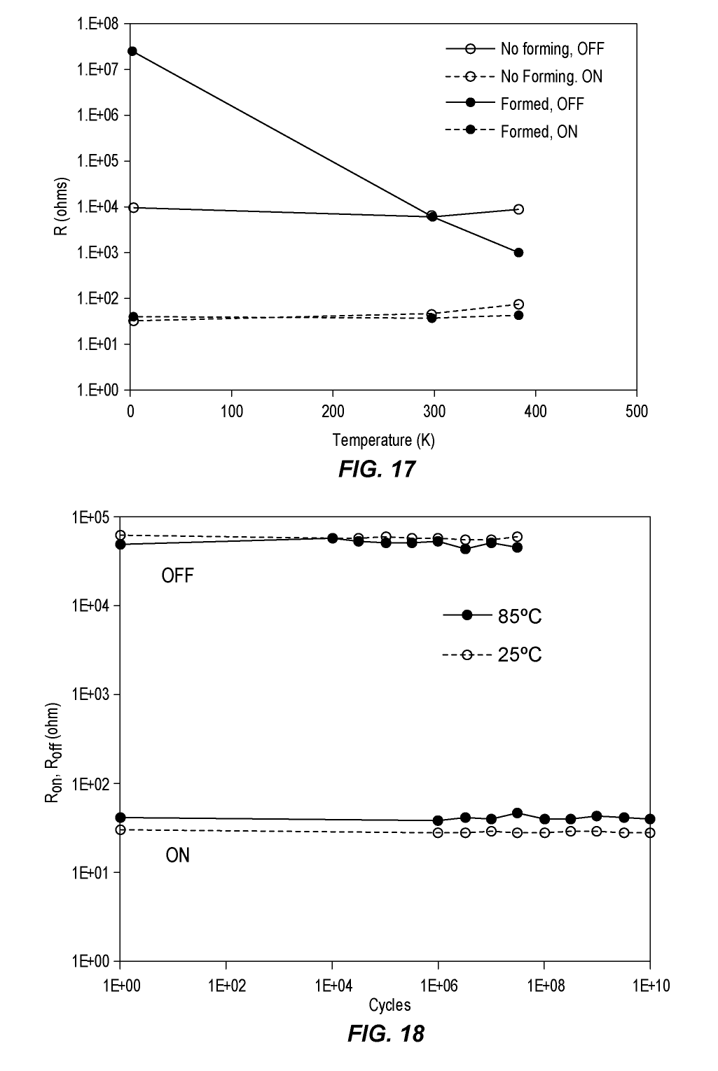

FIG. 17 shows a graph of Kelvin temperature versus resistance in Ohms for the ON and OFF states for a VRM thin film according to the invention and for a prior art thin film that crystallizes in the OFF state and requires forming before exhibiting variable resistance. As shown in the graph, for the VRM material, NiO(Lₓ) in this case, the ON and OFF states vary only a little with temperature over the entire 400° K temperature range. Both curves rise a little at the higher temperatures. The rise is essentially uniform for both the ON and OFF state, so the resistance window remains essentially the same. Clearly, a memory made with the VRM material will be stable over any temperature range that memories should be stable over. However, for the prior art NiO film, without carbon, the OFF state changes linearly with temperature, while the conducting state is essentially flat. The resistance window changes by more than 500%. Just over the reasonable range that a memory must work, from about 250° K to about 350° K, the memory window changes by about over 100%. This prior art material clearly could not be used in a memory.

FIG. 18 is a graph of number of reading cycles versus resistance in Ohms for the ON and OFF states for a VRM thin film according to the invention. Measurements were made at both 25° C. and 85° C. Reading fatigue measures the resistance in Ohms versus number of read cycles, where a read cycle comprises the application of a read voltage of one volt across the resistance element for a sufficient time to come to equilibrium with a reference voltage, followed by the removal of the voltage for a sufficient time to come to equilibrium at zero voltage. The measurements of reading fatigue were made for both the ON state and the OFF state at 85° C. and 25° C. The ON state was measured out to 10¹⁰ cycles, and the OFF state was measured only to 10⁸ cycles because of time constraints. Both curves were flat, i.e., showing essentially no change in the measured resistance values, for the 25° C. measurement, and showing a minor variation of about two percent for the 85° C. measurement. This graph demonstrates there is little or no fatigue for the VRM material. Thus, a memory made of VRM material will be stable over any conceivable number of read cycles. Write fatigue has not yet been measured due to time constraints, though every indication is that it also will be essentially nil.

The particular systems, memory designs, and methods described herein are intended to illustrate the functionality and versatility of the invention, but the invention should not be construed to be limited to those particular embodiments. It is evident that those skilled in the art may make numerous uses and modifications of the specific embodiments described, or equivalent structures and processes may be substituted for the structures and processed described. For example, the memory may have the variable resistance elements, and their associated transistors if applicable, arranged in columns or rows. Thus, herein, the arrangement is referred to as a row/column arrangement. Further, while in some instances the preferred type of semiconductor wafer has been specified, it should be understood that, in any of the devices described, any semiconductor can be used. Further, in many instances, the specific type of semiconductor has been specified, e.g., n-type, p-type, n+, p+, etc.; those skilled in the art will recognize that other types may be used. For example, most devices work essentially the same if n-type is replaced with p-type and p-type replaced with n-type. As another example, though platinum electrodes have been given as examples, those skilled in the art will recognize that such electrodes preferably are formed with a thin adhesive layer of titanium, and that the entire literature of oxide structures on platinum/titanium electrodes and the top electrode literature involving platinum, titanium, tungsten, aluminum, copper and other materials can be applied. Any place a semiconductor is mentioned, those skilled in the art will recognize that gallium arsenide, germanium, germanium/silicon, and other semiconductor technologies can be substituted. As mentioned above, the term “metal” or “M” is used herein to indicate any suitable conductor, including metals such as platinum and tungsten, or polysilicon, or other conventional conductors known in the art. Since certain changes may be made in the above systems and methods without departing from the scope of the invention, it is intended that all subject matter contained in the above description or shown in the accompanying drawings may be interpreted as illustrative and not in a limiting sense; consequently, the invention is to be construed as embracing each and every novel feature and novel combination of features present or inherently possessed by the systems, devices, and methods described in the claims below and their equivalents.

What is claimed as new and desired to be protected by Letters Patent of the United States is:

1. A method of making a resistive switching integrated circuit memory, said method comprising:
providing a substrate and a metallorganic or organometallic precursor including a metal moiety suitable for forming a desired variable resistance material (VRM);
applying said precursor to said substrate to form a thin film of said precursor;
heating said precursor on said substrate to form said VRM; and
completing said integrated circuit to include said VRM as an active element in said integrated circuit.

2. A precursor as in claim 1 wherein said solvent is a metallorganic solvent.

3. A method as in claim 2 wherein said precursor comprises octane.

4. A method as in claim 1 wherein said applying comprises a process selected from the group consisting of: spin-coating, dipping, liquid source misted deposition, chemical vapor deposition, and atomic layer deposition.

5. A method as in claim 1 wherein said heating comprises annealing in oxygen.

6. A method as in claim 1 wherein said heating comprises annealing in a gas containing at least one chemical element for forming a ligand which stabilizes the electronic properties of said VRM.

7. A method as in claim 6 wherein said gas comprises a gas selected from CO and CO₂.

8. A method as in claim 1 wherein said annealing comprises annealing in a gas containing the anion for said VRM.

9. A method as in claim 1 wherein metal VRM comprises nickel.

10. A method as in claim 1, and further comprising patterning said resistance switching material using an etch.

11. A method as in claim 10 wherein said etch comprises ion milling or reactive ion etching.

12. A method as in claim 1 wherein said heating comprises drying said thin film at a temperature between 100° C. and 300° C. and then annealing said thin film in a furnace at a temperature of between 450° C. and 650° C.

13. A method of making a variable resistance material, said method comprising:
providing a metallorganic or organometallic precursor including a metal moiety suitable for forming a desired variable resistance material (VRM);
applying said precursor to a substrate to form a thin film of said precursor; and
heating said precursor on said substrate to form said VRM.

14. A precursor as in claim 13 wherein said solvent is a metallorganic solvent.

15. A method as in claim 14 wherein said precursor comprises octane.

16. A method as in claim 13 wherein said applying comprises a process selected from the group consisting of: spin-coating, dipping, liquid source misted deposition, chemical vapor deposition, and atomic layer deposition.

17. A method as in claim 13 wherein said heating comprises annealing in oxygen.

18. A method as in claim 13 wherein said heating comprises annealing in a gas containing at least one chemical element for forming a ligand which stabilizes the electronic properties of said VRM.

19. A method as in claim 18 wherein said gas comprises a gas selected from CO and CO₂.

20. A method as in claim 13 wherein said metal moiety comprises nickel.

21. A precursor for making a variable resistance material (VRM), said precursor comprising a metallorganic or organometallic solvent and one or more metals.

22. A precursor as in claim 21 wherein said solvent is a metallorganic solvent.

23. A precursor as in claim 21 wherein said metallorganic solvent comprises octane.

24. A precursor as in claim 21 wherein said metal comprises a transition metal.

25. A precursor as in claim 24 wherein said transition metal comprises nickel.
